(19) United States
(12) Patent Application Publication
(10) Pub. No.: US 2004/0140885 A1
(43) Pub. Date: Jul. 22, 2004

(54) Vehicle security system

(76) Inventors: James M. Slicker, West Bloomfield, MI (US); Xiujuan S. Wang, Troy, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/346,386

(22) Filed: Jan. 17, 2003

(51) Int. Cl. B60R 25/10

(52) U.S. Cl. 340/426.1

(57) ABSTRACT

An invention is disclosed to make vehicles more secure. The disclosed system uses an intrusion subsystem to determine whether an intruder has entered a vehicle. If the intrusion subsystem detects an intruder, the identification subsystem can capture an identifying characteristic of the intruder through the use of an identification sensor. The identification sensor can be configured to consume no power until activated by a determination by the intrusion subsystem that an intruder has entered a vehicle. After an identifying characteristic has been captured by the identification subsystem, a response subsystem can be used by the system to generate a communication to a receiver outside the vehicle. That communication can include the identifying characteristic of the intruder. Such a communication can be received by private and government-run security centers. In some embodiments of the system, the identification sensor is a video camera that is used by an airbag deployment process.

### BACKGROUND OF THE INVENTION

The present invention relates in general to systems or methods involving to the security of a vehicle. In particular, the present invention relates to vehicle security systems or methods for detecting intrusions into a vehicle and then capturing an identifying characteristic of the intruder.

Existing vehicle security systems typically focus exclusively on detecting the occurrence of an intrusion into the vehicle by an intruder. For example, there are numerous different technologies that have been incorporated into various types of car alarms. However, such systems are prone to either generating false alarms, or missing true intrusion situations. Car alarms are often ignored due to the frequency of false alarms. Moreover, the imprecise nature and wide variety of intrusions makes it very difficult to fashion intrusion sensors that function at the high rate of accuracy at which other vehicle systems function. Thus, it would be desirable for a vehicle security system to focus attention on a wider range of information than merely whether or not an intrusion may have occurred. It would also be desirable if a vehicle security system could identify intruders to enhance the probability that such intruders are subsequently apprehended. Such functionality may further deter future would be intruders.

Although owners and operators of vehicles desire increased security functionality in their vehicles, purchasers of vehicles simultaneously require cost containment and even cost reduction on the vehicles they purchase. In order to reduce the cost of the security system, it would be desirable for at least one of the sensors used by the vehicle security system to be shared by other vehicle systems in order to make efficient use of vehicle components. It would also be desirable if sensors used to capture identifying characteristics of an intruder were only activated after the system concludes that an intrusion had occurred. Intrusions are an infrequent event, and the energy drain cause by a sensor constantly gathering sensor measurements would increase the power consumption and cost of a vehicle.

As vehicle intrusions are infrequent events, the interaction between vehicle operator and the security system should be similarly infrequent. If the security system is complicated, difficult to use, and subject to many false alarms, vehicle operators are likely to disable the functionality of a vehicle security system. It would be desirable for the system, once configured, to work in a manner that is transparent to the legitimate users of the vehicle.

### SUMMARY OF THE INVENTION

This invention relates to a system and method for identifying when a vehicle intrusion has occurred, and using one or more vehicle sensors to capture identifying information relating to the intruder.

The system can include an intrusion subsystem for detecting when an intrusion has occurred. Intrusions sensors, such as shock sensors in automotive embodiments, can be used to detect intrusions. In a preferred embodiment, intrusion sensors are set at maximum sensitivity since the primary impact of an intrusion determination is the activation of the identification subsystem.

An identification subsystem can be used to capture information relating to an intruder that will assist in identifying the individual. In a preferred automotive embodiment, the identification subsystem shares an identification sensor with another vehicle sensor, such as a video camera that is used by both the vehicle security system and an airbag deployment system. Intruder data, which depends on the type of identification sensor incorporated into the system, can be sent to a response subsystem for subsequent processing and communication.

A response subsystem can communicate the intruder data to the outside world by using wireless communication technologies. E-mails, instant messages, cell phones, and other technologies can be automatically invoked by the response subsystem. Such communications can be sent to receivers at a government security location or a private security center. The vehicle can also be configured to generate responses internally.

Various aspects of this invention will become apparent to those skilled in the art from the following detailed description of the preferred embodiment, when read in light of the accompanying drawings.

### BRIEF DESCRIPTION OF THE DRAWINGS

FIG. 1 illustrates one example of a partial high-level block diagram illustrating some of the elements and functions that can be incorporated into a vehicle security system 20.

FIG. 2 is an example of a partial view of the surrounding environment for one potential embodiment of the system 20, a system that shares an identification sensor 28 with an airbag deployment system.

FIG. 3 is process flow diagram illustrating one example of how sensor readings from an identification sensor can be used by other vehicle systems in addition to the vehicle security system.

FIG. 4 is a block diagram illustrating one example of a subsystem-level view of the vehicle security system.

FIG. 5 is a flow chart illustrating one example of the functionality that can be provided by the vehicle security system.

### DETAILED DESCRIPTION OF A PREFERRED EMBODIMENT

I. Introduction and Definitions

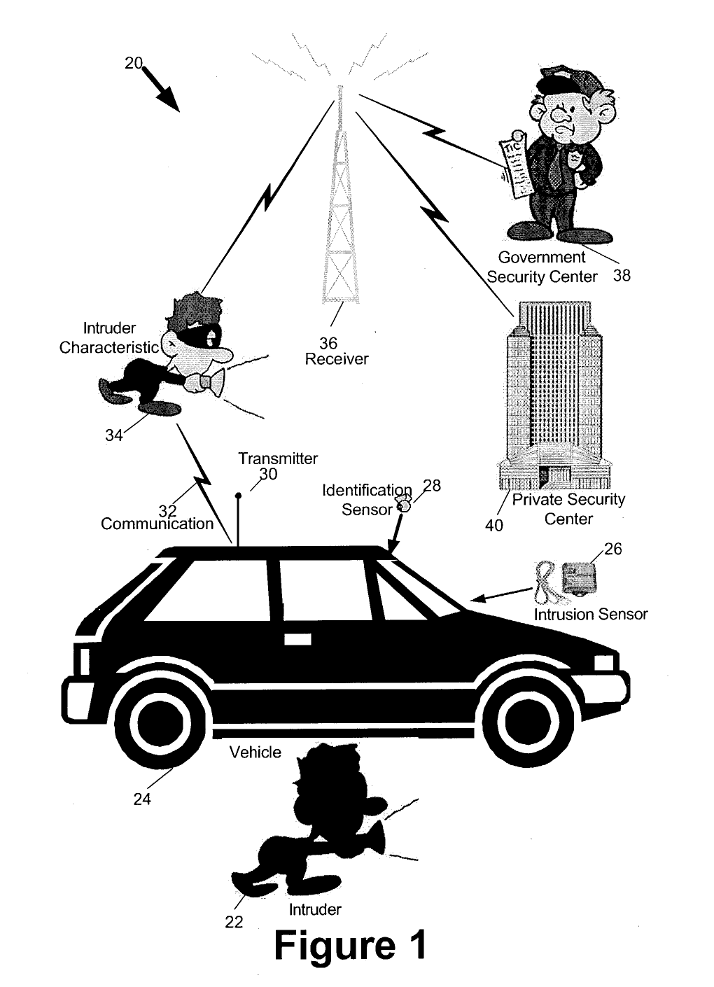

FIG. 1 illustrates one example of a high-level block diagram illustrating some of the elements and functions that can be incorporated into a vehicle security system 20. The system 20 is highly flexible and adaptable, capable of incorporating many different elements and variations of the example in the Figure.

A. Intruders

The system 20 detects an intrusion into a vehicle 24 by an intruder 22. The intruder 22 is typically a human being attempting to steal the vehicle 24. Intruders can include a human being attempting to: steal items within the vehicle 24; break into the vehicle 24; or merely damage the vehicle 24 from the outside. Intruders 22 can include non-human biological organisms such as animals capable of breaking into the vehicle 24. Non-biological mechanisms such as robots or remote control devices can also constitute intruders 22.

B. Vehicles

In some embodiments, the vehicle 24 is an automobile such as a car, Jeep®, truck, sport utility vehicle (SUV), golf cart, go-cart, moped, bus, tram, recreational vehicle (RV) or motorcycle. In alternative embodiments, the vehicle can be any type of transportation device, such as a forklift (or other industrial equipment), plane, boat, helicopter, spacecraft, submarine, satellite, subway, train, or other transportation device.

C. Sensors

The system 20 uses various sensors to detect and identify intruders 22. Regardless of the type of vehicle 24, the system 20 can include an intrusion detection sensor (intrusion sensor 26) for detecting whether or not an intrusion has occurred within the vehicle and an intruder identification sensor (identification sensor 28) for capturing one or more identification characteristics relating to the intruder 22. In many embodiments of the system 20, the intrusion sensor 26 will be different than the identification sensor 28 because different sensor types have different relative strengths and weaknesses. However, in some embodiments of the system 20, the intrusion sensor 26 can be the same device as the identification sensor 28.

1. Intrusion Sensor

In some embodiments of the system 20, the intrusion sensor 26 is a shock sensor. Shock sensors can be installed in a vehicle 24 such as an automobile to detect the breaking of a window. Shock sensors are currently popular in the aftermarket alarm systems market, and are well known in the art. Shock sensors tend to be overly sensitive, contributing to a high false alarm rate. However, the system 20 uses an intrusion sensor 26 to determine when the identification sensor 28 should be activated, so it is preferable for the intrusion sensor 26 to generate false alarms rather than miss actual intrusion situations. The system 20 can incorporate a wide variety of different sensors as intrusion sensors 26. In some embodiments of the system 20, the intrusion sensor 26 can be configured to the highest level of sensitivity possible, with no alarm being generated to avoid the nuisance of many false alarms. In such embodiments, the primary purpose of the intrusion sensor 26 is to activate the identification sensor 28 described below. In other embodiments, the intrusion sensor 26 generates an alarm as is typical under prior art embodiments, in addition to activating the identification sensor 28.

A wide variety of different sensor types can be used as intrusion sensors 26 by the system 20. Some embodiments of the system 20 can presume that any entry into the vehicle 22 is an intrusion unless the person performs a particular act to alarm mechanisms that automatically assume the opening of the vehicle 22 is an intrusion unless the sensor is temporarily turned off: through the use of a remote entry device; the entering of personal identification number (PIN) or similar code; or some other security or biometric technology. Infrared beams, video cameras, lock tampering detection technologies, video cameras and many other different sensor technologies may be used as intrusion sensors 26 by the system 20. The system 20 may incorporate more than one intrusion sensor 26, and such sensors may be of more than one sensor type. Upon detection of the intruder 22, the intrusion sensor 26 generates an intrusion determination that activates the identification sensor 28.

2. Identification Sensor

In many embodiments of the system 20, the identification sensor 28 is turned off and consumes no power until activated by an intrusion determination by the identification sensor 28. In other embodiments, the identification sensor 28 is always active.

The identification sensor 28 can be any sensor capable of capturing one or more identifying characteristics (e.g. an intruder characteristic 34) relating to the intruder 22. In some embodiments of the system 20, the identification sensor 28 is a video camera and the identifying characteristic is an image of the intruder 22. The image of the intruder 22 can be an ambient image of the intruder 22 and the area surrounding the intruder 22. In other visual embodiments, the image of the intruder 22 is a segmented image of the intruder 22, an image consisting solely of the intruder. The system 20 can also incorporate non-video camera identification sensors 28 and even non-visual identification sensors 28. Infrared sensors, retina scans, fingerprint mechanisms, voice prints, and other biometric-related sensors can be identification sensors 28 used by the system 20

D. Intruder Characteristic(s)

Just as a wide variety of different sensors can serve as identification sensors 28 in the system 20, the system 20 can also track a wide variety of different intruder characteristics 34. Voice prints, finger prints, DNA, retina patterns, and any other biometric characteristic can be an intruder characteristic 34 tracked by the system 20. In many embodiments of the system 20, the intruder characteristic 34 is an image of the intruder 22. In some image embodiments, the image is an ambient image. In other embodiments, the image is a segmented image. If the identification sensor 28 is a video camera shared with another system in the vehicle 22 such as an airbag deployment system, the airbag deployment system can provide a means for isolating a segmented image of the intruder 22

E. Communication

The intruder characteristic(s) 34 is incorporated into a communication 32 that is sent outside of the vehicle 24 to a receiver 36 from a transmitter 30. The communication 32 can in a wide variety of wireless formats. The communication 32 can be in the form of an e-mail, an instant message, a cellular transmission, or any other type of communication that can be sent and received in a wireless fashion. The different types of transmitters 30 used by the system 20 can vary as widely as the different types of communication 32 mechanisms.

F. Receiver

A receiver 36 can be any device outside of the vehicle 24 capable of receiving the communication. In some embodiments of the system 20, the receiver 36 is operated by a governmental or public organization (e.g. a government security center 38) such as a police department. In other embodiments, the receiver 36 is operated by a private entity (e.g. a private security center 40). In some embodiments, biometric analysis such as facial identification technology are automatically applied to visual images of the intruder 22 that are sent to the receiver 36. Depending on the form of the intruder characteristic 34 and the mode of communication 32, both the transmitter 30 and the receiver 36 may be two-way transceivers, in selective two-way contact with each other, permitting inquiries by centers 38 or 40 described below. Further, if no communication 32 is possible, the intruder characteristic 34 may be stored locally within the vehicle for later local or remote retrieval. The system 20 can interface with existing vehicle security systems such as LoJack® and OnStar® in the activation of alarms, and the capturing, storing, and communicating of intruder characteristics 34. The system 20 can be used to capture and send pictures when such other systems detect an intruder 22.

II. Integration with Other Vehicle Systems

In a preferred automotive embodiment of the system 20, the system 20 utilizes shared sensors, sensors that are also used by other vehicle systems. For example, an airbag deployment system can use a video camera or similar image-based sensor to capture occupant characteristics relevant to determining the appropriate airbag deployment decision. Such a video camera could also be used as an identification sensor 28 because it is designed to capture driver and passenger images.

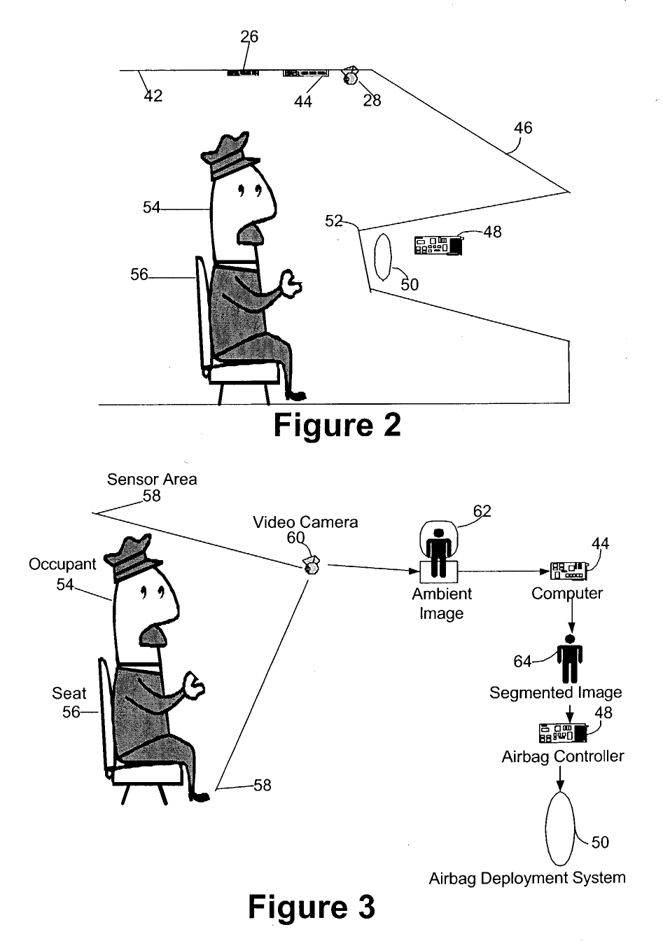

FIG. 2 is a partial view of the surrounding environment for one potential embodiment of the system 20 that shares an identification sensor 28 with an airbag deployment system. If an occupant 54 is present, the occupant 54 sits on a seat 56. In the case of an intruder 22, the occupant 54 is the intruder 22. In a preferred embodiment, the identification sensor 28 is a video camera or other imaging sensor capable of rapidly capturing a series of images is attached in a roof liner 42, above the occupant 54 and in a position closer to a front windshield 46 than the occupant 54. The identification sensor 28 could be a standard video camera, but for crash detection purposes, a high speed camera 22 capable of capturing between 250 and 1000 frames per second may be preferable. The identification sensor 28 should preferably be placed in a slightly downward angle towards the occupant 54 in order to capture changes in the angle and position of the occupant's 54 upper torso resulting from forward or backward movement in the seat 56. There are many other potential locations for the identification sensor 28 that can be incorporated into the system 20.

The location of the intrusion sensor 26 depends on the type of intrusion sensor 26 being deployed. In the case of a shock sensor, the “brain” of the shock sensor can be stored in many different locations, such as in the roof liner. The various locations and implementation methods for shock sensors are known in the art. A computer 44 for processing the inputs of the various sensors can also be located in a wide variety of different locations in the vehicle 24. In some embodiments, the same computer 44 used for processing by the vehicle security system 20 is used by other systems utilizing the shared sensors, such as an airbag deployment system. In other embodiments, the computer 44 used for security system 20 processing is exclusive to security functionality. In a preferred embodiment, the computer 44 is located near the identification sensor 28 to avoid sending camera images through long wires.

An airbag controller 48 and an airbag 50 are shown in an instrument panel 52, although the airbag controller could be located virtually anywhere in the vehicle. The system 20 can share intrusion sensors 26 and identification sensors 28 with a wide range of different vehicle systems.

III. Process Flow of Image Processing

FIG. 3 discloses a high-level process flow relating to the use of the system 20 in the context of overall image processing in an embodiment of the system 20 that uses a video camera or other image-based identification sensor 28.

An incoming video image (“ambient image”) 62 of a sensor area 58 (e.g. seat area) includes both the occupant 54 and images in the sensor area 58 that surrounds the occupant 54. The incoming video image 62 is captured by the video camera 60 or any other sensor capable of rapidly capturing a series of images. In the Figure, the seat area 58 includes the entire occupant 54, although under some circumstances and embodiments, only a portion of the occupant's 54 image will be captured, particularly if the camera 60 is positioned in a location where the lower extremities may not be viewable. The ambient image 62 is sent to the computer 44.

Many functions in the airbag deployment process can be performed in one or more computers 44. The computer 44 can be used to isolate a segmented image 64 of the occupant 54 from the ambient image 62 of the seat area 58 that includes both the occupant 54 and the area surrounding the occupant 54. The system 20 can utilize the ambient image 62, the segmented image 64, both images, or specific characteristics relating to the captured images. The process of identifying the pixels within the segmented that represent the upper torso of the occupant 54 can be housed in the computer 44. The process of extracting occupant characteristics from the upper torso for security and non-security functions can be performed within the computer 44. The computer 44 can be any device capable of running a computer program or some other form of structured logic.

Depending on the results of the processing performed by the computer 44, the appropriate instructions can be sent to the airbag controller 48 for deployment of the airbag 50.

IV. Subsystem View

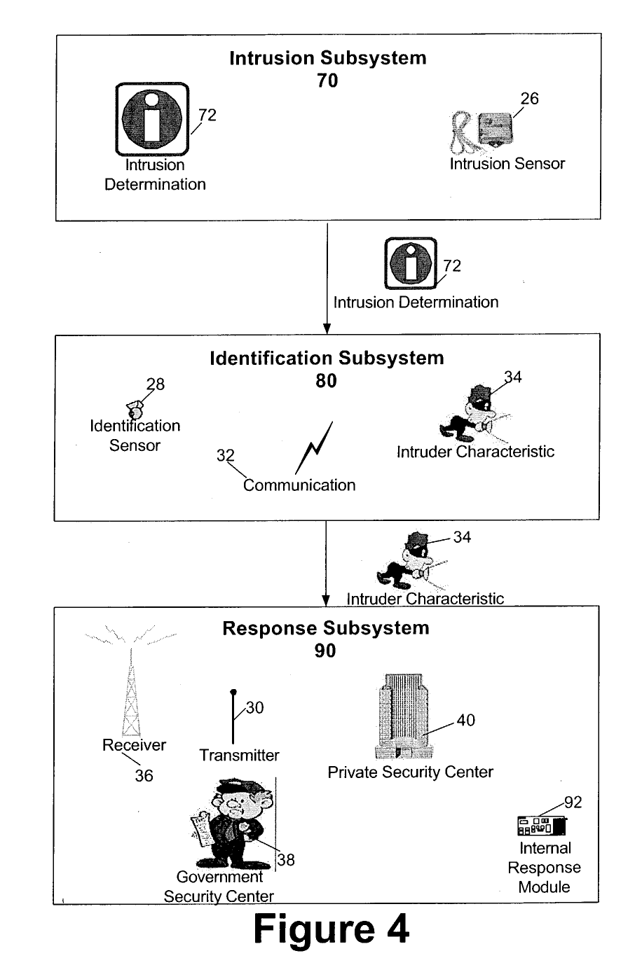

FIG. 4 is a block diagram illustrating one example of the subsystems that can be incorporated into the system 20.

A. Intrusion Subsystem

An intrusion subsystem 70 is used by the system 20 to detect an intrusion into a vehicle 24 by an intruder 22. The intrusion subsystem 70 includes the intrusion sensor 26 to generate an intrusion determination 72. In a preferred automotive embodiment, the intrusion sensor 26 is a shock sensor. In alternative automotive embodiments, and in non-automotive embodiments, a wider range of different intrusion sensors 26 can be used by the system 20. The system 20 can use more than one intrusion sensor 26. The intrusion determination 72 can be sent to an identification subsystem 80 described below. In a preferred automotive embodiment, the identification subsystem 80 is activated by a determination that an intruder 22 has entered the vehicle 24.

B. Identification Subsystem

The identification subsystem 80 uses one or more identification sensors 28 to capture one or more identifying characteristics relating to the intruder 22 (e.g. intruder characteristics 34). In a preferred automotive embodiment, the identification sensor 28 is a video camera 60 shared with other vehicle 24 systems, such as an airbag deployment system. In such an embodiment, the intruder characteristic 34 is an image of the intruder 22. The type of sensor used determines the nature of the intruder characteristics 34. The system 20 can incorporate a wide range of different identification sensors 28 and intruder characteristics 34. Intruder characteristics 34 are sent to a response subsystem 90 to become part of one or more communications 32 sent out by the response subsystem 90.

C. Response Subsystem

a response subsystem 90 sends out the communication 22 of the identification subsystem 80 and sends it to a receiver 36 outside of the vehicle. This communication 22 can be automatically generated and sent out by the system 20 without any human interaction. The communication 32 can be in the form of any wireless communication, including e-mail, instant messaging, cellular phone, or any other existing or future wireless technology. The receiver 36 can be any device capable of receiving the communication. The receiver 36 can be operated at government security center 38 such as a police station or a private security center 40 run by a security company. The response subsystem 90 can also include an internal response module 92 for initiating actions within the vehicle itself. For example, the vehicle 22 could be disabled after confirming that the driver is an intruder 22, and not the owner of the vehicle 22. A wide range of different internal responses can be incorporated into the internal response module 92.

Depending on the form of the intruder characteristic 34 and the mode of communication 32, both the transmitter 30 and the receiver 36 may be two-way transceivers, in selective two-way contact with each other, permitting inquiries by centers 38 or 40 described below. Further, if no communication 32 is possible, the intruder characteristic 34 may be stored locally within the vehicle for later local or remote retrieval. The system 20 can interface with existing vehicle security systems such as LoJack® and OnStar® in the activation of alarms, and the capturing, storing, and communicating of intruder characteristics 34. The system 20 can be used to capture and send pictures when such other systems detect an intruder 22. The system 20 can also be configured to send intruder characteristics to multiple centers 40, such as the centers for those other security systems.

V. Process Flow

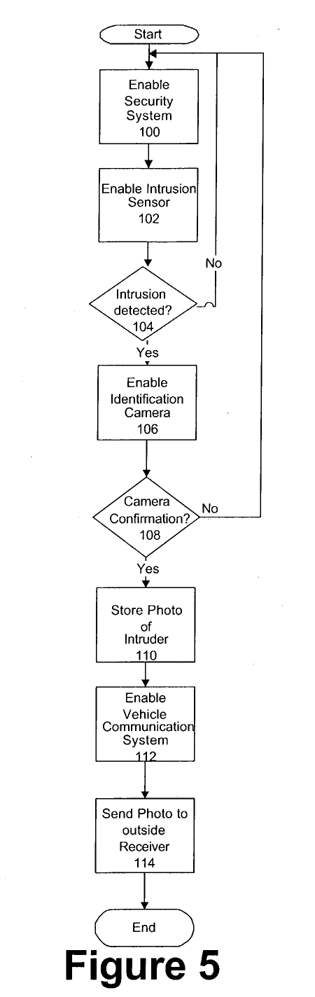

FIG. 5 is a flow chart illustrating one example of how the system 20 can function using a picture as the intruder characteristic 34. At 100, the system 20 is enabled. This can be done automatically by the owner or driver of the vehicle shutting off the engine and locking the door. In other embodiments, the activation of the system 20 occurs only by a specific action by a user of the system 20. For example, the system 20 could be activated by a remote wireless key, a voice-command, the typing in of a code, or virtually any other mechanism.

At 102, the intrusion subsystem 70 is automatically activated with the activation of the system 20. In contrast, the identification subsystem 80 and response subsystem 90 are not automatically activated upon the activation of the system 20. By not activating those subsystems until an intruder 22 is detected, the system 20 conserves power.

At 104, the intrusion subsystem 70 awaits for an intrusion determination 72, e.g. a determination that an intruder 22 has intruded into the vehicle 24. An intrusion can be defined as starting up the vehicle 24, entering the vehicle 24, breaking into a vehicle 24, or even merely vandalizing a vehicle 24 from outside the vehicle 24. Until an intrusion is detected at 104, the system 20 merely determines whether or not it should remain on by looping from 100 through 104.

If an intrusion is detected at 104, the system 20 can then activate the identification subsystem 80 and the identification sensor 28 at 106. This also activates one or more identification sensors 28 which capture one or more intruder characteristics 34. In a video camera 60 embodiment, the video camera captures an image of the intruder 34 that is then sent to the response subsystem 90.

At 108, the identification subsystem 80 can confirm whether or not an intruder 32 is detectible using the identification sensor 28. If the identification subsystem 80 does not detect the presence of the intruder 22, processing can return to step 100. In some embodiments, a sensor reading is captured without attempting to confirm whether or not an intruder 22 exists. For example, the system 20 can capture an image of the seat area that does not indicate an intruder 22 is in the seat area.

At 110, the intruder characteristic 34 is stored by the system 20 for subsequent processing. In a preferred automotive embodiment, the intruder characteristic 34 is an ambient or segmented image of the intruder 22 captured with a video camera 60 used by an airbag deployment system in the vehicle 24.

At 112, the response subsystem 90 is activated by the capturing of intruder characteristics 34. The response subsystem 90 as described above can facilitate a wide range of system 20 responses to the invasion of the vehicle 24 by the intruder 22.

At 114, the wide range of responses by the response subsystem 90 can be performed by the system 20. The range of responses includes sending the communication 32 to the receiver 36, which can be operated by both public and private entities.

In accordance with the provisions of the patent statutes, the principles and modes of operation of this invention have been explained and illustrated in multiple preferred and alternative embodiments. However, it must be understood that this invention may be practiced otherwise than is specifically explained and illustrated without departing from its spirit or scope.

What is claimed is:

1. A vehicle security system, comprising:
a intrusion subsystem, including an intrusion sensor and a intrusion determination, wherein said intrusion subsystem provides for generating said intrusion determination with said intrusion sensor;
an identification subsystem, including an identification sensor and an identifying characteristic, wherein said identification subsystem provides for capturing said identifying characteristic with said identification sensor and said intrusion determination.

2. The vehicle security system of claim 1, wherein the vehicle is an automobile.

3. The vehicle security system of claim 1, wherein said identification sensor is an airbag sensor.

4. The vehicle security system of claim 3, wherein said airbag sensor is a video camera and said identifying characteristic is an image.

5. The vehicle security system of claim 1, wherein said intrusion sensor is a shock sensor.

6. The vehicle security system of claim 1, wherein said intrusion subsystem activates said identification subsystem with said intrusion determination.

7. The vehicle security system of claim 1, further comprising a response subsystem, said response subsystem including a communication comprising said identifying characteristic, wherein said response subsystem provides for generating said communication.

8. The vehicle security system of claim 7, wherein said communication is an automatically generated e-mail message.

9. The vehicle security system of claim 7, wherein said communication is an automatically generated cellular phone transmission.

10. The vehicle security system of claim 7, wherein said communication is received by a security center.

11. A vehicle security system, comprising:
a intrusion subsystem, including a shock sensor and a intrusion determination, wherein said intrusion subsystem provides for generating said intrusion determination with said shock sensor;
an identification subsystem, including a video camera and an intruder image, wherein said identification subsystem provides for capturing said intruder image with said video camera, wherein said identification subsystem is activated by said intrusion determination from said intrusion subsystem, wherein said intruder image is captured within an automobile, and wherein said video camera is an airbag sensor; and
a response subsystem, including an automatically generated communication comprising said intruder image, wherein said response subsystem provides for sending said automatically generated communication to a receiver outside of the automobile.

12. The vehicle security system of claim 11, wherein said automatically generated communication is an e-mail.

13. The vehicle security system of claim 11, wherein said video camera consumes no electricity until activated by said intrusion determination from said intrusion subsystem.

14. The vehicle security system of claim 11, wherein said intruder image is a segmented image.

15. A method of creating a vehicle security system, comprising:
installing a shock sensor to generate an intrusion determination after detecting an intruder; and
configuring an identification sensor to capture an intruder image after said shock sensor generates said intrusion determination, wherein said identification sensor is a video camera.

16. The method of claim 15, wherein said identification sensor is an airbag sensor.

17. The method of claim 15, further comprising connecting a transmission device to said identification sensor to transmit said intruder image to receiver outside of the vehicle.

18. The method of claim 17, wherein said vehicle is an automobile.

19. The method of claim 18, wherein said receiver is part of a private security center.

20. The method of claim 17, wherein the identification sensor is configured to consume no power until said shock sensor generates said intrusion determination.
